(19) United States
(12) Patent Application Publication
(10) Pub. No.: US 2025/0225967 A1
(43) Pub. Date: Jul. 10, 2025

(54) SILENCING STRUCTURE

(71) Applicant: FUJIFILM Corporation, Tokyo (JP)

(72) Inventors: Shinya HAKUTA, Ashigarakami-gun (JP); Shogo YAMAZOE, Ashigarakami-gun (JP); Yoshihiro SUGAWARA, Ashigarakami-gun (JP); Yuichiro ITAI, Ashigarakami-gun (JP); Shun ISHIGE, Ashigarakami-gun (JP); Tomohiro TAKAHASHI, Ashigarakami-gun (JP)

(73) Assignee: FUJIFILM Corporation, Tokyo (JP)

(21) Appl. No.: 19/092,029

(22) Filed: Mar. 27, 2025

Related U.S. Application Data
(63) Continuation of application No. PCT/JP2023/034419, filed on Sep. 22, 2023.

(30) Foreign Application Priority Data
Oct. 28, 2022 (JP) 2022-173563

(51) Int. Cl. G10K 11/175; G10K 11/162

(52) U.S. Cl. CPC G10K 11/175; G10K 11/162

(57) ABSTRACT

Provided is a silencing structure that uses interference and can be miniaturized while ensuring silencing performance. A silencing structure includes: a main flow passage that is connected to an inlet and an outlet; a sub-flow passage that branches off from the main flow passage and returns to the main flow passage; and a sound absorbing material that is disposed at least at a connection position between the main flow passage and the sub-flow passage. The sub-flow passage is not directly connected to the inlet and the outlet, and a length of a path that is from the inlet to the outlet and includes only the main flow passage is equal to or less than a length of a path that is from the inlet to the outlet and includes the sub-flow passage. For a sound with a frequency to be cancelled, a phase difference between a sound that passes through the path including only the main flow passage and a sound that passes through the path including the sub-flow passage is greater than 90 degrees and less than 270 degrees such that interference occurs to deaden the sound.

### CROSS-REFERENCE TO RELATED APPLICATIONS

This application is a Continuation of PCT International Application No. PCT/JP2023/034419 filed on Sep. 22, 2023, which claims priority under 35 U.S.C. § 119 (a) to Japanese Patent Application No. 2022-173563 filed on Oct. 28, 2022. The above applications are hereby expressly incorporated by reference, in their entirety, into the present application.

### BACKGROUND OF THE INVENTION

### 1. Field of the Invention

The present invention relates to a silencing structure.

### 2. Description of the Related Art

A silencer deadens sound using interference.

For example, JP1986-147317U (JP-S61-147317U) discloses an interference-type silencer in which a plurality of exhaust gas branch passages having different flow passage lengths are provided in a portion of an exhaust pipe of an automobile engine or the like and the exhaust gas passages are joined to the exhaust pipe.

### SUMMARY OF THE INVENTION

In the silencer using interference, a length difference of λ/2 is required, and there is a limit to miniaturization.

An object of the present invention is to solve the above-described problems of the related art and to provide a silencing structure that uses interference and can be miniaturized while ensuring silencing performance.

In order to achieve the object, the present invention has the following configurations.
[1] According to an aspect of the present invention, there is provided a silencing structure including: a main flow passage that is connected to an inlet and an outlet; a sub-flow passage that branches off from the main flow passage and returns to the main flow passage; and a sound absorbing material that is disposed at least at a connection position between the main flow passage and the sub-flow passage, in which the sub-flow passage is not directly connected to the inlet and the outlet, a length of a path that is from the inlet to the outlet and includes the sub-flow passage is equal to or greater than a length of a path that is from the inlet to the outlet and includes only the main flow passage, and, for a sound with a frequency to be cancelled, a phase difference between a sound that passes through the path including only the main flow passage and a sound that passes through the path including the sub-flow passage is greater than 90 degrees and less than 270 degrees such that interference occurs to deaden the sound.
[2] In the silencing structure according to [1], a total thickness of the sound absorbing material is equal to or greater than 10 mm in a direction of the path including the sub-flow passage.
[3] In the silencing structure according to [1] or [2], the main flow passage and the sub-flow passage are separated by a non-air-permeable wall member except for the connection position.
[4] In the silencing structure according to any one of [1] to [3], a viscous characteristic length of the sound absorbing material is equal to or less than 300 μm.
[5] In the silencing structure according to any one of [1] to [4], a tortuosity of the sound absorbing material is equal to or greater than 1.1.
[6] The silencing structure according to any one of [1] to [5] further includes: an expansion portion that is expanded more than an area of the inlet and the outlet; and a wall member that is disposed in the expansion portion and defines the main flow passage communicating from the inlet to the outlet, in which a region of the expansion portion, which is separated from the main flow passage by the wall member, is the sub-flow passage.
[7] In the silencing structure according to any one of [1] to [6], the sound absorbing material has a foam structure.
[8] In the silencing structure according to any one of [1] to [7], the main flow passage is a ventilation passage.
[9] In the silencing structure according to any one of [1] to [8], a fan is connected to the inlet such that the main flow passage acts as a ventilation passage, and a sound of the fan is the sound to be deadened.

According to the present invention, it is possible to provide a silencing structure that uses interference and can be miniaturized while ensuring silencing performance.

### BRIEF DESCRIPTION OF THE DRAWINGS

FIG. 1 is a cross-sectional view conceptually showing an example of a silencing structure according to an embodiment of the present invention.

FIG. 2 is a cross-sectional view taken along a line A-A of FIG. 1.

FIG. 3 is a cross-sectional view taken along a line B-B of FIG. 1.

FIG. 4 is a view showing a phase of sound passing through the silencing structure.

FIG. 5 is a cross-sectional view conceptually showing another example of the silencing structure according to the embodiment of the present invention.

FIG. 6 is a graph showing a relationship between a frequency and a transmission loss.

FIG. 7 is a graph showing a relationship between a frequency and a transmission loss.

FIG. 8 is a view showing the phase of sound passing through the silencing structure.

FIG. 9 is a graph showing a relationship between a frequency and a transmission loss.

FIG. 10 is a view showing the phase of sound passing through the silencing structure.

FIG. 11 is a graph showing the relationship between the frequency and the transmission loss.

FIG. 12 is a cross-sectional view showing the silencing structure for describing a configuration according to the example.

FIG. 13 is a graph showing the relationship between the frequency and the transmission loss.

FIG. 14 is a graph showing a relationship between a thickness of a sound absorbing material and a peak frequency.

FIG. 15 is a graph showing a relationship between tortuosity and a peak silencing frequency.

FIG. 16 is a graph showing a relationship among a viscous characteristic length, the tortuosity, and a speed of sound.

FIG. 17 is a graph showing the relationship between the viscous characteristic length, the tortuosity, and the speed of sound.

FIG. 18 is a graph showing the relationship between the viscous characteristic length, the tortuosity, and the speed of sound.

FIG. 19 is a cross-sectional view conceptually showing another example of the silencing structure according to the embodiment of the present invention.

FIG. 20 is a view showing the phase of sound passing through the silencing structure.

### DESCRIPTION OF THE PREFERRED EMBODIMENTS

Hereinafter, the present invention will be described in detail.

Configuration requirements will be described below based on a representative embodiment of the present invention. However, the present invention is not limited to the embodiment.

In addition, in the present specification, a numerical range represented by “to” means a range including numerical values described before and after “to” as a lower limit value and an upper limit value.

Furthermore, in the present specification, “being orthogonal”, “being perpendicular”, and “being parallel” include the range of errors to be allowed in a technical field to which the present invention belongs. For example, “being orthogonal”, “being perpendicular”, and “being parallel” mean being within a range of less than +10° with respect to being strictly orthogonal, perpendicular, and parallel, and an error with respect to being orthogonal, perpendicular, or parallel is preferably equal to or less than 5° and more preferably equal to or less than 3°.

In the present specification, it is assumed that the term “same” or the like includes an error range that is generally allowable in the technical field.

### [Silencing Structure]

A silencing structure according to an embodiment of the present invention includes: a main flow passage that is connected to an inlet and an outlet; a sub-flow passage that branches off from the main flow passage and returns to the main flow passage; and a sound absorbing material that is disposed at least at a connection position between the main flow passage and the sub-flow passage. The sub-flow passage is not directly connected to the inlet and the outlet, and a length of a path that is from the inlet to the outlet and includes only the main flow passage is equal to or less than a length of a path that is from the inlet to the outlet and includes the sub-flow passage. For a sound with a frequency to be cancelled, a phase difference between a sound that passes through the path including only the main flow passage and a sound that passes through the path including the sub-flow passage is greater than 90 degrees and less than 270 degrees such that interference occurs to deaden the sound.

A configuration of the silencing structure according to the embodiment of the present invention will be described with reference to the drawings.

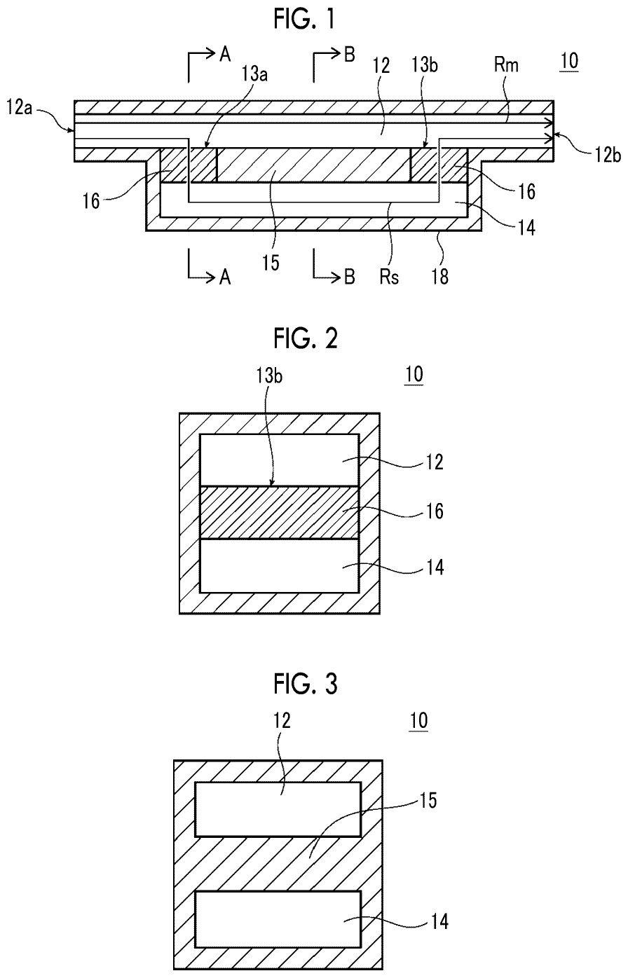

FIG. 1 is a schematic cross-sectional view showing an example of an embodiment of the silencing structure according to the present invention. FIG. 2 is a cross-sectional view taken along a line A-A of FIG. 1. FIG. 3 is a cross-sectional view taken along a line B-B of FIG. 1.

A silencing structure 10 shown in FIG. 1 includes a ventilation pipe constituting a main flow passage 12, a ventilation pipe constituting a sub-flow passage 14 that branches off from the main flow passage 12 and joins the main flow passage 12, and a sound absorbing material 16.

The main flow passage 12 is a flow passage that is connected to an inlet 12a and an outlet 12b. In the example shown in the drawing, the main flow passage 12 is a linear flow passage from the inlet 12a to the outlet 12b. In addition, the shape and size of the main flow passage 12 in a cross section perpendicular to a flow passage direction are constant from the inlet 12a to the outlet 12b. In the example shown in FIGS. 1 to 3, the cross-sectional shape of the main flow passage is a substantially rectangular shape.

A connection position 13a that is connected to the sub-flow passage 14 at a position closer to the inlet 12a and a connection position 13b that is connected to the sub-flow passage 14 at a position closer to the outlet 12b are formed in a lower surface of the main flow passage 12 in FIG. 1.

The sub-flow passage 14 is a flow passage that branches off from the main flow passage 12 at the connection position 13a and returns to the main flow passage 12 at the connection position 13b. That is, the connection position 13a is a branch portion, and the connection position 13b is a junction portion. In the example shown in FIGS. 1 to 3, the sub-flow passage 14 has: a first part that extends from the connection position 13a in a direction substantially orthogonal to the flow passage direction of the main flow passage 12, that is, downward in the example shown in the drawings; a second part that extends from an end portion of the first part opposite to the connection position 13a, that is, a lower end portion in the example shown in the drawings to the outlet 12b in a direction substantially parallel to the flow passage direction of the main flow passage 12, that is, in a left-right direction in the example shown in the drawings; and a third part that extends from an end portion of the second part opposite to the first part, that is, a right end portion in the example shown in the drawings to the connection position 13b in a direction substantially orthogonal to the flow passage direction of the main flow passage 12, that is, upward in the example shown in the drawings.

The shape and size of the sub-flow passage 14 in the cross section perpendicular to the flow passage direction are constant from the connection position 13a to the connection position 13b. In addition, the flow passage direction in the first part of the sub-flow passage 14 is an up-down direction in the drawings, the flow passage direction in the second part is the left-right direction in the drawings, and the flow passage direction in the third part is the up-down direction in the drawings. In the example shown in FIGS. 1 to 3, the cross-sectional shape of the sub-flow passage is a substantially rectangular shape.

The sub-flow passage 14 is only connected to the main flow passage 12 at the connection position 13a and the connection position 13b, but is not directly connected to the inlet 12a and the outlet 12b. In addition, the main flow passage 12 and the sub-flow passage 14 are separated by a non-air-permeable wall member 15 except for the connection position 13a and the connection position 13b.

Here, a length of a path (path length Rs) in a case of passing through the sub-flow passage 14 is equal to or larger than a path length Rm in a case of passing only through the main flow passage 12. In addition, the path length Rm in a case of passing only through the main flow passage 12 is a length of the main flow passage 12 from the inlet 12a to the outlet 12b in the flow passage direction. Further, the path length Rs in a case of passing through the sub-flow passage 14 is the sum of the length of the main flow passage 12 from the inlet 12a to the connection position 13a in the flow passage direction, the length of the sub-flow passage 14 from the connection position 13a to the connection position 13b in the flow passage direction, and the length of the main flow passage 12 from the connection position 13b to the outlet 12b in the flow passage direction.

The sound absorbing material 16 is disposed at least at the connection positions 13a and 13b between the main flow passage 12 and the sub-flow passage 14. In the example shown in the drawings, the sound absorbing material 16 is disposed in each of the first part and the second part of the sub-flow passage 14. The shape and size of the sound absorbing material 16 in the cross section perpendicular to the flow passage direction of the first part and the second part are substantially the same as the cross-sectional shape and size of the sub-flow passage 14, and a portion of the sub-flow passage 14 is filled with the sound absorbing material 16.

In addition, in the example shown in the drawings, as a preferred aspect, the sound absorbing material 16 is not disposed in the main flow passage 12 and is disposed to be flush with the wall member (the wall member on the lower side in FIG. 1) in which the connection positions 13a and 13b are formed.

The silencing structure 10 delays the phase of the sound passing through the path including the sub-flow passage 14, using the passage of the sound through the sound absorbing material 16 in a case where the sound passes through the path including the sub-flow passage 14, in addition to the difference in path length between the main flow passage 12 and the sub-flow passage 14. Since the sound absorbing material 16 has a complex internal structure, the sound absorbing material 16 has the effect of slowing down the speed of sound passing through the sound absorbing material 16. Therefore, in a case where sound passes through the sound absorbing material 16, the phase delay is larger than that in a case where sound propagates through the air having the same length. For sound with a frequency to be cancelled, the silencing structure 10 sets the phase difference between the sound passing through the path including only the main flow passage 12 and the sound passing through the path including the sub-flow passage 14 to be greater than 90 degrees and less than 270 degrees, using the effect of the sound absorbing material 16, in addition to the difference in path length between the main flow passage 12 and the sub-flow passage 14 such that interference occurs to deaden the sound.

As described above, the interference-type silencer according to the related art is provided with branch passages having different flow passage lengths to shift the phase of sound by λ/2. As a result, interference occurs to deaden the sound. Therefore, it is necessary to secure a length difference of λ/2 with respect to the wavelength λ of the sound to be deadened in the branch passages. Therefore, there is a limit to miniaturization. In particular, since the wavelength λ of low-frequency sound is large, the size of the silencer is further increased.

In contrast, the silencing structure according to the embodiment of the present invention includes the sound absorbing material 16 disposed at the connection position between the main flow passage 12 and the sub-flow passage 14. Therefore, in a case where sound passes through the path including the sub-flow passage 14, the sound passes through the sound absorbing material 16, which makes it possible to delay the phase of the sound passing through the path including the sub-flow passage 14. Therefore, even in a case where a geometric length difference between the path length Rm in a case of passing only through the main flow passage 12 and the path length Rs in a case of passing through the sub-flow passage 14 is less than λ/2 with respect to the wavelength λ of the sound to be deadened, it is possible to adjust the phase difference between the sound passing only through the main flow passage 12 and the sound passing through the sub-flow passage 14 to be greater than 90 degrees and less than 270 degrees and thus to deadened the sound using interference. Therefore, it is possible to miniaturize the silencing structure. In addition, since the sound absorbing material 16 is light, it is possible to reduce the weight of the entire silencing structure.

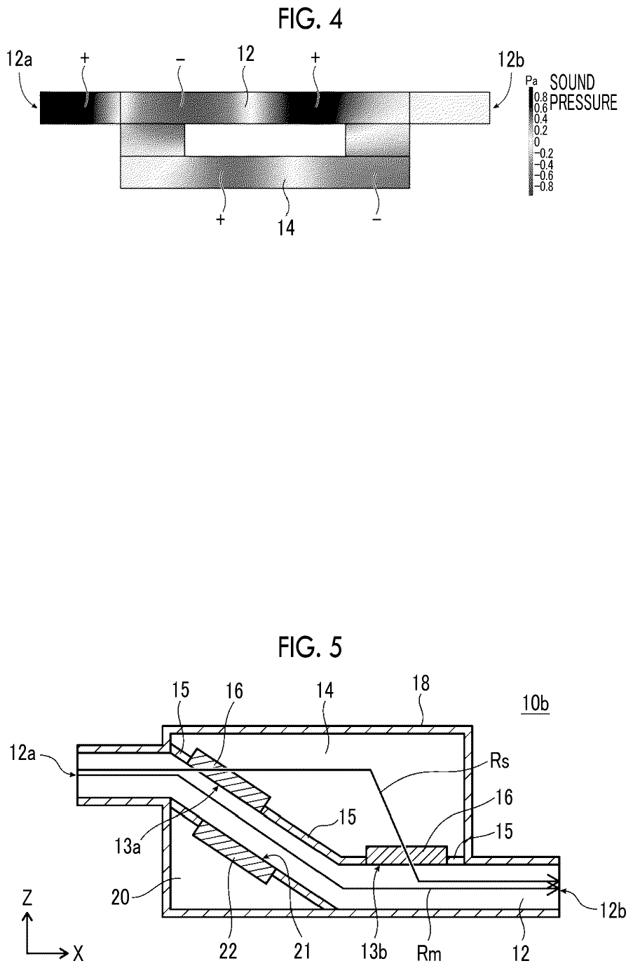

FIG. 4 is a view showing a sound pressure distribution in the silencing structure calculated by simulation in Example 1 which will be described below. As shown in FIG. 4, the phase of the sound pressure of the sound passing only through the main flow passage 12 is substantially opposite to the phase of the sound pressure of the sound passing through the sub-flow passage 14 at the connection position 13b which is the junction portion. Therefore, phase cancellation occurs in the flow passage after the connection position 13b due to interference, and the sound is deadened.

Here, from the viewpoint of obtaining a higher silencing effect, for the sound having the frequency to be cancelled, the phase difference between the sound passing only through the main flow passage 12 and the sound passing through the sub-flow passage 14 is preferably 135° to 225° and more preferably 160° to 200°.

Here, the definition of the phase difference is “abs (Δθ) mod 360” (the value of the remainder in a case where the absolute value of the phase difference between two paths is divided by 360 degrees) in a case where the phase difference between the main flow passage and the sub-flow passage is Δθ.

In addition, in the silencing structure according to the embodiment of the present invention, in a case where a sound having a lower frequency is to be deadened, the frequency of the sound to be deadened is preferably 50 Hz to 4000 Hz and more preferably 100 Hz to 3000 Hz from the viewpoint of easily obtaining the effect of miniaturization.

In addition, from the viewpoint of easily imparting the phase difference between the sound passing only through the main flow passage 12 and the sound passing through the sub-flow passage 14, the total thickness of the sound absorbing material 16 in the direction of the path including the sub-flow passage is preferably equal to or greater than 10 mm, more preferably equal to or greater than 15 mm, and still more preferably equal to or greater than 20 mm.

On the other hand, in a case where the total thickness of the sound absorbing material 16 is excessively large, the sound pressure of the sound passing through the sub-flow passage 14 is reduced by the sound absorption effect of converting sound energy into heat energy due to friction during the passage of the sound through the sound absorbing material 16. As a result, there is a concern that the silencing effect will be reduced due to cancellation caused by interference even in a case where the phase difference with the sound passing only through the main flow passage 12 is appropriate. Therefore, the total thickness of the sound absorbing material 16 in the direction of the path including the sub-flow passage is preferably equal to or less than 100 mm, more preferably equal to or less than 60 mm, and still more preferably equal to or less than 40 mm.

Further, in the example shown in FIG. 1, the total thickness of the sound absorbing material 16 in the direction of the path including the sub-flow passage 14 is the sum of the thickness of the sound absorbing material 16 disposed in the first part of the sub-flow passage 14 in the up-down direction and the thickness of the sound absorbing material 16 disposed in the second part in the up-down direction.

In addition, in the example shown in FIG. 1, the sound absorbing material 16 is disposed in a portion of the sub-flow passage 14. However, the present invention is not limited thereto, and the sound absorbing material 16 may be disposed in the entire sub-flow passage 14. However, in a case where the sound absorbing material 16 is disposed in the entire sub-flow passage 14, there is a concern that the sound absorption effect of the sound absorbing material 16 will be increased and the silencing effect obtained by cancellation caused by interference will be reduced. Therefore, it is preferable that the sound absorbing material 16 is disposed in a portion of the sub-flow passage 14.

In addition, in the example shown in FIG. 1, the sound absorbing material 16 is disposed near each of the connection position 13a (branch portion) and the connection position 13b (junction portion) between the main flow passage 12 and the sub-flow passage 14 in the sub-flow passage 14. However, the present invention is not limited thereto. For example, in addition to the sound absorbing material 16 disposed near the connection position 13a and the connection position 13b between the main flow passage 12 and the sub-flow passage 14 in the sub-flow passage 14, a sound absorbing material that is disposed in a portion of the second part of the sub-flow passage 14 may be further provided. In addition, a sound absorbing material that is disposed in at least a portion of the second part of the sub-flow passage 14 may be provided. In a case where the main flow passage 12 is used as a ventilation passage, it is preferable that the sound absorbing material 16 is disposed near each of the connection position 13a and the connection position 13b between the main flow passage 12 and the sub-flow passage 14 such that the inflow of wind into the sub-flow passage 14 can be prevented.

As in the example shown in FIG. 1, it is preferable that the sound absorbing material 16 is disposed near each of the connection position 13a and the connection position 13b of the sub-flow passage 14 to be flush with the wall member (the wall member on the lower side in FIG. 1) in which the connection positions 13a and 13b are formed.

Assuming that at least a portion of the sound absorbing material 16 is disposed in the main flow passage 12, for example, in a case where the silencing structure 10 is connected to a ventilation pipe and the main flow passage 12 is used as a ventilation passage, the sound absorbing material 16 hinders ventilation. Therefore, there is a concern that the amount of ventilation will be reduced. In addition, in a case where the sound absorbing material 16 is disposed at a position other than the connection position 13a and the connection position 13b of the sub-flow passage 14, steps are formed at the connection position 13a and the connection position 13b. Therefore, there is a concern that wind flowing through the main flow passage 12 will be disturbed and wind noise will occur.

The sound absorbing material 16 blocks most of the wind and allows sound to pass through. Therefore, in a case where the sound absorbing material 16 is disposed to be flush with the wall member in which the connection positions 13a and 13b are formed, it is possible to prevent the sound absorbing material 16 from hindering ventilation. In addition, it is possible to prevent the occurrence of wind noise.

In addition, from the viewpoint of reducing the sound absorption effect of the sound absorbing material 16 while increasing the effect of imparting the phase difference by the sound absorbing material 16, a viscous characteristic length of the sound absorbing material 16 is preferably equal to or less than 300 μm, more preferably equal to or greater than 1 μm and equal to or less than 100 μm, still more preferably equal to or greater than 5 μm and equal to or less than 70 μm, and particularly preferably equal to or greater than 10 μm and equal to or less than 50 μm.

From the same viewpoint, the tortuosity of the sound absorbing material 16 is preferably equal to or greater than 1.1, more preferably equal to or greater than 1.2 and equal to or less than 5.0, and still more preferably equal to or greater than 1.5 and equal to or less than 4.0.

Here, the viscous characteristic length is a quantity related to the effective density of a porous material in a Johnson-Champoux-Allard-Lafarge model (JCA model) or a Biot model and indicates a viscous loss (attenuation) caused by the violent movement of air in a narrowed void portion. It can be said that, as the viscous characteristic length is smaller, the sound absorption effect of converting sound energy into thermal energy due to friction is lower.

The tortuosity is one of parameters related to a fluid (air) filling a porous material, indicates the complexity of voids in a porous elastic body, and is defined as the ratio of the speed of sound to the speed of sound in air at a high frequency limit. Therefore, the speed of sound passing through the sound absorbing material is measured using ultrasonic waves exceeding an audible range, and the ratio of the speed of sound to the speed of sound propagating in the air is measured. Higher tortuosity means a more complex internal structure, and it can be said that the effect of slowing down the speed of sound passing through the inside of the porous material is higher.

The viscous characteristic length and the tortuosity can be measured using, for example, “Torvith” manufactured by Nihon Onkyo Engineering Co., Ltd. The tortuosity is defined as the ratio of the speed of sound to the speed of sound in air at the high frequency limit. Therefore, the tortuosity can be calculated by measuring the speed of sound passing through the sound absorbing material using a high-frequency sound (ultrasonic wave) exceeding the audible range and by measuring the ratio of the measured speed of sound to the speed of sound in air. The viscous characteristic length can be measured using two kinds of gases having different sound speeds such as air and argon. The measurement may be performed with another similar measurement device or a self-made device according to the definition. In addition, a fine structure may be calculated by a scanning electron microscope (SEM), 3D-computed tomography (CT) scanning, a laser microscope, or the like and may be modeled, and the viscous characteristic length and the tortuosity may be determined by fluid calculation according to the definition.

In the Johnson-Champoux-Allard-Lafarge model (JCA model) or the Biot model that adds the vibration of a solid portion of the sound absorbing material, effective parameters (density p and elastic modulus K) related to the absorption of an air portion can be expressed as shown in the following Expressions (1) and (2). From the two parameters, the speed inside the sound absorbing material is √(K/ρ).

$$\begin{matrix}[ Equation 1 ] & \\ \overline{ρ} ( ω ) = \frac{{α}_{∞} {ρ}_{0}}{ϕ} [ 1 + \frac{σϕ}{i ω {ρ}_{0} {α}_{∞}} \sqrt{1 + i \frac{4 {α}_{∞}^{2} μ {ρ}_{0} ω}{{σ}^{2} {A}^{2} {ϕ}^{2}}} ] & ( 1 )\end{matrix}$$

$$\begin{matrix}[ Equation 2 ] & \\ \tilde{K} ( ω ) = \frac{γ {P}_{0} / ϕ}{γ - {( γ - 1 ) [ 1 - i \frac{8 κ}{{Λ}^{′ 2} ω} \sqrt{1 + i \frac{{Λ}^{′2} ω}{16 κ}} ]}^{- 1}} & ( 2 )\end{matrix}$$

In addition, α_{∞} indicates tortuosity, ρ₀ indicates the density of air, φ indicates porosity, σ indicates flow resistance, i indicates an imaginary unit, ω indicates an angular frequency, μ indicates the viscosity of air, Λ indicates a viscous characteristic length, γ indicates a specific heat ratio, P₀ indicates pressure at equilibrium, k indicates thermal diffusivity, and Λ′ indicates a thermal characteristic length.

In order to obtain the sound absorbing material satisfying the ranges of the viscous characteristic length and the tortuosity, it is preferable to use a porous sound absorbing material having a foam structure as the sound absorbing material, rather than woven fabric or nonwoven fabric. This is because the tortuosity of the nonwoven fabric sound absorbing materials is approximately 1. The porous sound absorbing material having the foam structure, such as urethane foam, can have a structure in which the tortuosity is significantly greater than 1. In addition, for the porous sound absorbing material having the foam structure, the tortuosity and the viscous characteristic length can be set to preferable ranges by artificially producing the foam structure using a 3D printer or the like.

Any sound absorbing material known in the related art can be appropriately used as the sound absorbing material. For example, various known sound absorbing materials can be used, such as a foam body, a foaming material (foaming urethane foam (for example, Calmflex F manufactured by Inoac Corporation, urethane foam manufactured by Hikari Co., Ltd., and the like), flexible urethane foam, a ceramic particle sintered material, phenol foam, melamine foam, polyamide foam, and the like), a nonwoven sound absorbing material (a microfiber nonwoven fabric (for example, Thinsulate manufactured by 3M or the like), a polyester nonwoven fabric (for example, White Q-ON manufactured by Tokyo Bouon Co., Ltd., QonPET manufactured by Bridgestone KBG Co., Ltd., Micromat manufactured by Softprene Industry Corporation, and these products are also provided in a two-layer structure of a front thin nonwoven fabric having a high density and a back nonwoven fabric having a low density), a plastic nonwoven fabric, such as an acrylic fiber nonwoven fabric, a natural fiber nonwoven fabric, such as wool or felt, a metal nonwoven fabric, a glass nonwoven fabric, and the like), and a material including a minute amount of air (glass wool, rock wool, or a nanofiber-based fiber sound absorbing material (silica nanofiber, acrylic nanofiber (for example, XAI manufactured by Mitsubishi Chemical Corporation))).

Urethane foam, such as Calmflex F2, F4, F6, and F9 manufactured by Inoac Corporation or Everlight manufactured by Arkem Corporation, can be preferably used as the porous sound absorbing material having the foam structure.

In addition, a sound absorbing material having an artificial and bottom-up foam structure can be produced by a device capable of producing a fine three-dimensional structure, such as a 3D printer. For example, since the size of pores in the sound absorbing urethane is about 1 mm, the sound absorbing urethane can be produced with sufficient resolution even with a commercially available 3D printer. According to this method, it is possible to change both the tortuosity and the viscous characteristic length to any values.

Further, a geometric length difference between the path length Rm in a case of passing only through the main flow passage 12 and the path length Rs in a case of passing through the sub-flow passage 14 is not particularly limited as long as Rm≤Rs is established. However, the difference is desirably equal to or greater than λ/8 and more desirably equal to or greater than λ/4 from the viewpoint of miniaturization while ensuring the phase difference of the sound to be deadened.

Furthermore, in the example shown in FIGS. 1 to 3, the cross-sectional shape of the main flow passage 12 and the sub-flow passage 14 is a substantially rectangular shape. However, the present invention is not limited thereto, and the cross-sectional shape may be various shapes such as a circular shape and a triangular shape. The cross-sectional shape of the main flow passage 12 and the cross-sectional shape of the sub-flow passage 14 may be different from each other. In addition, each of the main flow passage 12 and the sub-flow passage 14 may not have a constant cross-sectional shape and/or a constant cross-sectional area in the flow passage direction. For example, the diameter may change in the flow passage direction.

Furthermore, in the example shown in FIGS. 1 to 3, the sub-flow passage 14 is bent in a joint portion between the first part and the second part and is bent in a joint portion between the second part and the third part. However, the present invention is not limited thereto. The sub-flow passage 14 may have one or three or more bent portions in which the pipe line is bent, or may have a curved structure in which the pipe line is curved. In addition, the sub-flow passage 14 may have a structure having the bent portion and the curved structure.

Further, in the example shown in FIGS. 1 to 3, the main flow passage 12 has a straight pipe shape. However, the present invention is not limited thereto. The main flow passage 12 may have a bent portion in which the pipe line is bent and/or a curved structure in which the pipe line is curved.

For example, as in a silencing structure 10b shown in FIG. 5, the main flow passage 12 may be configured to have a fourth part that extends in the left-right direction (hereinafter, referred to as an X direction) in FIG. 5, a fifth part that is inclined from one side to the other side (the lower side in FIG. 5) in a Z direction (a direction orthogonal to the X direction, the up-down direction in FIG. 5) as it extends from the fourth part in the X direction, and a sixth part that extends from the fifth part in the X direction. That is, the main flow passage 12 of the silencing structure 10b shown in FIG. 5 has two bent portions in which the pipe line is bent, and the positions of the inlet 12a and the outlet 12b in the Z direction are different from each other.

In the example shown in FIG. 5, the silencing structure 10b has a pipe line that forms the main flow passage 12 near the inlet 12a, a pipe line that forms the main flow passage 12 near the outlet 12b, and an expansion portion 18 that is expanded more than the cross-sectional area of these pipe lines. It can be said that the example shown in the drawing is a configuration in which the pipe line closer to the inlet 12a is connected to one side surface of the expansion portion 18, which has a hollow rectangular parallelepiped shape, in the X direction and the pipe line closer to the outlet 12b is connected to the other side surface of the expansion portion 18. In addition, the position where the pipe line closer to the inlet 12a is connected to the expansion portion 18 and the position where the pipe line closer to the outlet 12b is connected to the expansion portion 18 in the Z direction are different from each other.

A wall member 15 that defines the main flow passage 12 such that the inlet 12a and the outlet 12b communicate with each other is disposed in the expansion portion 18. In the example shown in the drawing, the wall member 15 is formed such that the main flow passage 12 is bent in a joint portion between the pipe line closer to the inlet 12a and the expansion portion 18, is inclined from one side to the other side (the lower side in FIG. 5) in the Z direction as the main flow passage 12 extends in the X direction, extends in the X direction from a position where the main flow passage 12 reaches the other side surface of the expansion portion 18 in the Z direction, and is joined to the pipe line closer to the outlet 12b.

In addition, among regions separated by the wall member 15 in the expansion portion 18, a region different from a region that is the main flow passage 12 is the sub-flow passage 14. In the example shown in the drawing, a region on the upper side of the main flow passage 12 is the sub-flow passage 14. Opening portions that are the connection positions 13a and 13b between the main flow passage 12 and the sub-flow passage 14 are formed in the wall member 15.

The sound absorbing material 16 is disposed at each of the connection position 13a and the connection position 13b of the sub-flow passage 14.

Even in the silencing structure 10b having this configuration, in a case where sound passes through a path including the sub-flow passage 14, the sound passes through the sound absorbing material 16, which makes it possible to delay the phase of the sound passing through the path including the sub-flow passage 14. Therefore, even in a case where the geometric length difference between the path length Rm in a case of passing only through the main flow passage 12 and the path length Rs in a case of passing through the sub-flow passage 14 is less than λ/2 with respect to the wavelength λ of the sound to be deadened, the phase difference between the sound passing only through the main flow passage 12 and the sound passing through the sub-flow passage 14 can be greater than 90° and less than 270°, and thus it is possible to deaden sound using interference. Therefore, it is possible to miniaturize the silencing structure.

Further, in the example shown in FIG. 5, the thickness of the sound absorbing material 16 is a thickness in a direction orthogonal to the flow passage direction of the main flow passage 12. That is, in the example shown in FIG. 5, the thickness of the sound absorbing material 16 disposed at the connection position 13a is a thickness in a direction perpendicular to an opening surface that is the connection position 13a, and the thickness of the sound absorbing material 16 disposed at the connection position 13b is a thickness in a direction perpendicular to an opening surface that is the connection position 13b.

In general, a numerical simulation is performed on the silencing structure to determine the propagation direction of sound at each position and to determine the traveling direction of sound in the sound absorbing material, which makes it possible to calculate the “thickness of the sound absorbing material” as the sum of the lengths in the traveling directions.

In addition, in the example shown in FIG. 5, a back space 20 is also formed on the lower left side of the main flow passage 12 by partitioning the inside of the expansion portion 18 with the wall member 15. In the example shown in the drawing, the back space 20 and the main flow passage 12 communicate with each other through an opening portion 21 that is formed in the wall member 15, and a sound absorbing material 22 is disposed at the position of the opening portion 21. That is, it can be said that the sound absorbing material 22 is provided adjacent to the main flow passage 12 and the back space 20 is provided on the side of the sound absorbing material 22 opposite to the main flow passage 12. This configuration can prevent sound waves that have entered the sound absorbing material 22 from the main flow passage 12 from being reflected and returning to the main flow passage 12. Therefore, it is possible to further improve the sound absorption effect of the sound absorbing material 22.

As described above, the silencing structure according to the embodiment of the present invention may have a structure that exhibits the sound absorption effect of the normal sound absorbing material 22, in addition to the structure in which the phase difference between the sound passing only through the main flow passage 12 and the sound passing through the sub-flow passage 14 is imparted by the main flow passage 12, the sub-flow passage 14, and the sound absorbing material 16 and the sound is deadened by interference.

In addition, in the example shown in FIG. 1, one sub-flow passage 14 is provided. However, the present invention is not limited thereto, and a configuration may be adopted in which two or more sub-flow passages are provided. In the case of the configuration in which two or more sub-flow passages are provided, the phase difference between the sound passing through the path including only the main flow passage and the sound passing through the path including each sub-flow passage may be imparted, and the sound may be deadened by interference. In this case, the frequencies of the sounds to be deadened in the respective sub-flow passages may be different from each other. That is, for example, in a configuration in which two sub-flow passages are provided, the frequency of the sound to be deadened in a first sub-flow passage is f₁, a phase difference between the sound with the frequency f₁ passing through a path including the first sub-flow passage and the sound with the frequency f₁ passing through a path including only the main flow passage is greater than 90° and less than 270°, the frequency of the sound to be deadened in a second sub-flow passage is f₂, and a phase difference between the sound with the frequency f₂ passing through a path including the second sub-flow passage and the sound with the frequency f₂ passing through the path including only the main flow passage is greater than 90° and less than 270°. In this case, the sound with the frequency f₁ and the sound with the frequency f₂ can be deadened by interference.

In this case, in order to provide a configuration that an appropriate phase difference is imparted between the sounds to be deadened, the geometric path length in a case of passing through the first sub-flow passage may be different from the geometric path length in a case of passing through the second sub-flow passage, or parameters (a thickness, a viscous characteristic length, tortuosity, and the like) of the sound absorbing material disposed in the first sub-flow passage may be different from parameters (a thickness, a viscous characteristic length, tortuosity, and the like) of the sound absorbing material disposed in the second sub-flow passage. Alternatively, both may be performed.

In addition, assuming that the silencing structure according to the embodiment of the present invention is connected to another pipe line and then used, it is desirable that the outer peripheral surfaces of the inlet and outlet of the silencing structure have an uneven shape and/or a bellows shape. In a case where the silencing structure is connected to another pipe line, the silencing structure is firmly tightened. Therefore, it is possible to prevent wind leakage, sound leakage, sound reflection, and the like.

A housing that constitutes the main flow passage and the sub-flow passage may be configured, for example, by disposing a plurality of plate materials in a box shape and bonding the plate materials adjacent to each other with an adhesive, a pressure sensitive adhesive, solder, fusion, or the like. Alternatively, in a case where the housing is divided into two parts and fragmented, the housing may be configured by producing each fragment with injection molding, a 3D printer, or the like and combining the fragments with each other.

Examples of a material forming the housing that constitutes the main flow passage and the sub-flow passage include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamideimide, polyalylate, polyetherimide, polyacetal, polyetheretherketone, polyphenylene sulfide, polysulfone, polyethylene terephthalate, polybutylene terephthalate (PBT), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. Also, examples of the reinforced plastic material include carbon fiber reinforced plastics (CFRP) and glass fiber reinforced plastics (GFRP).

From the viewpoint of weight reduction, ease of molding, and the like, it is preferable to use a resin material as the material forming the housing. In addition, from the viewpoint of low-frequency range sound insulation, it is preferable to use a material having a high stiffness. From the viewpoints of weight reduction and sound insulation, it is preferable that the density of the members constituting the silencing structure is 0.5 g/cm³ to 2.5 g/cm³.

It is desirable that these materials have incombustibility, flame retardance, and self-extinguishing properties. In addition, it is also desirable that the entire silencing structure has incombustibility, flame retardance, and self-extinguishing properties.

The silencing structure according to the embodiment of the present invention can be used as a silencer that is connected to a ventilation passage through which a fluid (gas) flows. In this case, the main flow passage can be used as the ventilation passage.

For example, the silencing structure according to the embodiment of the present invention may be connected to a ventilation passage through which wind generated by a fan flows. Alternatively, a fan may be connected to the inlet of the silencing structure. In these cases, a configuration can be adopted in which the main flow passage acts as the ventilation passage and sound generated by the fan is treated as the sound to be deadened to cancel fan noise.

### EXAMPLES

Hereinafter, the present invention will be described in more detail with reference to examples. The materials, amounts used, proportions, treatment contents, treatment procedures, and the like shown in the following examples can be modified as appropriate without departing from the gist of the present invention. Therefore, the scope of the present invention should not be construed as being limited to the examples.

### Example 1

Acrylic plates (thickness of 3 mm) were processed with a laser cutter, and the processed acrylic plates were combined to form a rectangular cylindrical member having an opening of 20 mm×20 mm and a length of 100 mm and a hollow U-shaped member that branched off from the cylindrical member and then joined the cylindrical member, thereby producing the structure having the main flow passage and the sub-flow passage shown in FIG.

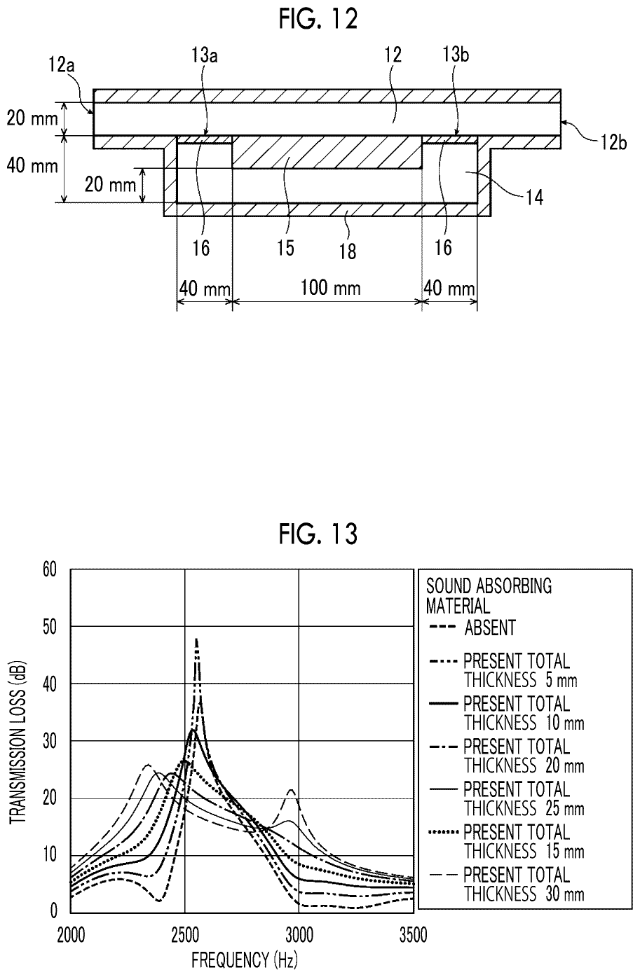

1. A joint portion between the acrylic plates was sealed with an adhesive and a tape. The dimensions of each portion were as shown in FIG. 12.

In addition, sound absorbing materials (QonPET manufactured by Bridgestone KBG Co., Ltd.) were disposed at the connection positions between the main flow passage and the sub-flow passage to produce a silencing structure. The sound absorbing material had a thickness of 20 mm, a viscous characteristic length of 100 μm, and a tortuosity of 1.0.

### Example 2

A silencing structure was produced in the same manner as in Example 1 except that Calmflex F6 manufactured by Inoac Corporation was used as the sound absorbing material. The sound absorbing material had a thickness of 20 mm, a viscous characteristic length of 100 μm, and a tortuosity of 1.5.

### Comparative Example 1

A silencing structure was produced in the same manner as in Example 1 except that the sound absorbing material was not disposed.

### [Evaluation]

A transmission loss of the produced silencing structure was measured. In the measurement, the transmittance was measured using a speaker and four terminals of a microphone according to a transfer function method (ASTM E2611) with an acoustic tube, and the transmission loss was calculated.

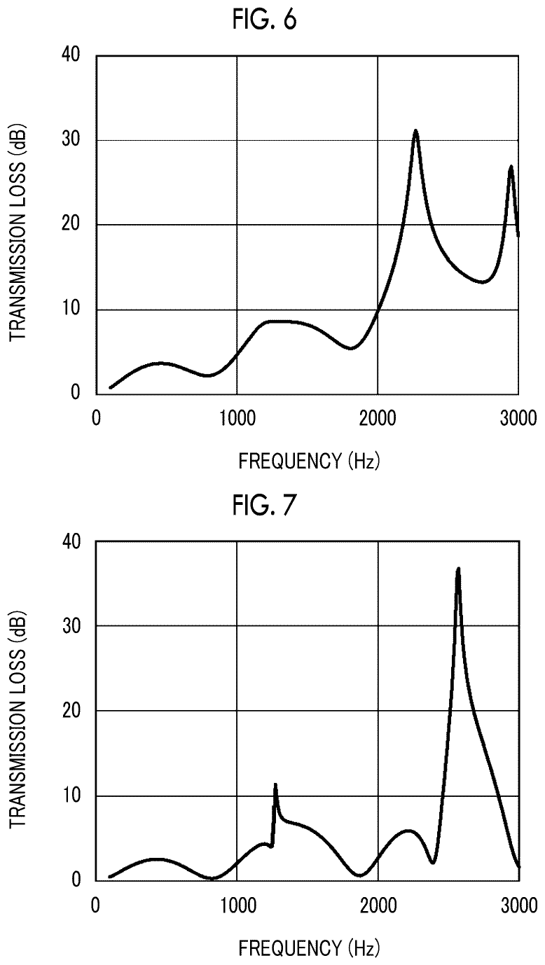

FIG. 6 shows the measurement results of the transmission loss of Example 1. FIG. 7 shows the measurement results of the transmission loss of Comparative Example 1. FIG. 9 shows the measurement results of the transmission loss of Example 2. In addition, FIG. 11 shows a summary of these results.

In addition, the silencing structures according to each of the examples and the comparative example were modeled, and a simulation was performed using a finite element method (COMSOL MultiPhysics ver. 6.0, COMSOL Inc.) to obtain sound pressure distributions in the silencing structures. In addition, the sound absorbing material was modeled with the JCA model.

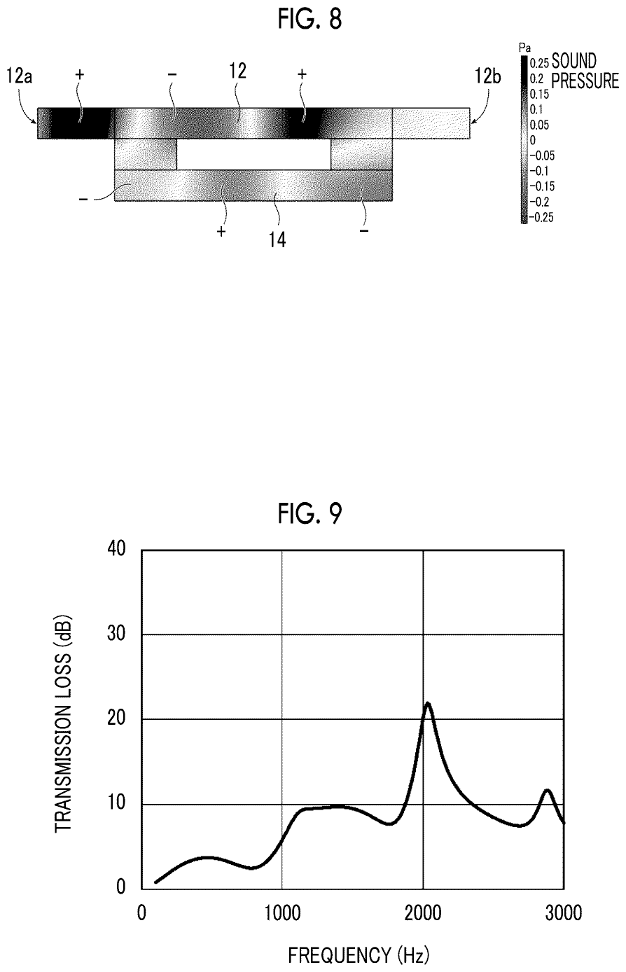

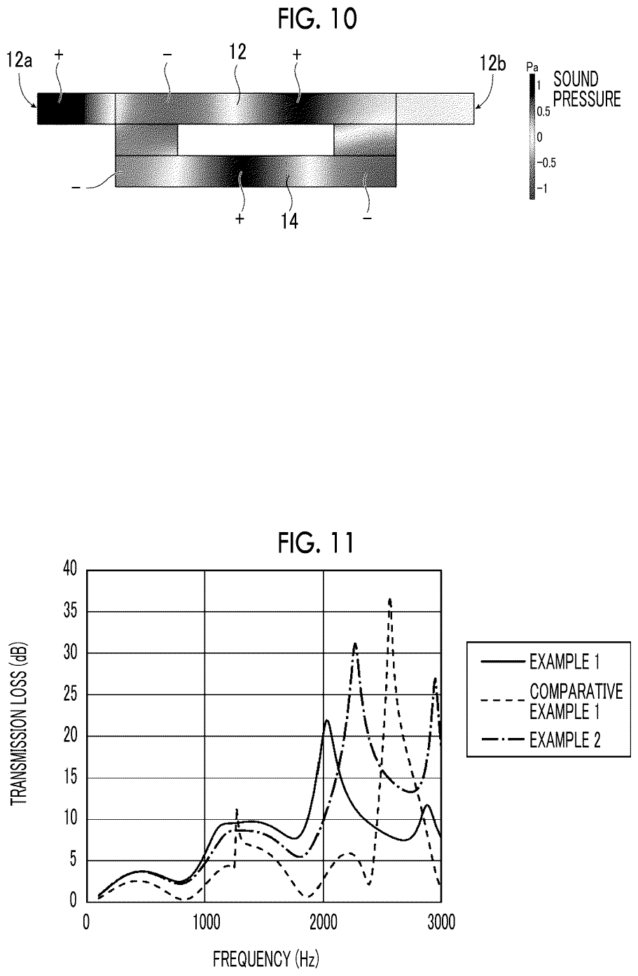

FIG. 4 shows the sound pressure distribution at a frequency of 2.27 kHz in Example 1. FIG. 8 shows the sound pressure distribution at a frequency of 2.57 kHz in Comparative Example 1. FIG. 10 shows the sound pressure distribution at a frequency of 2.03 kHz in Example 2.

As can be seen from FIG. 7, in Comparative Example 1, a high transmission loss appears at a frequency of 2.57 kHz. In addition, as can be seen from FIG. 8, at a frequency of 2.57 kHz, the phase of the sound pressure is inverted in the junction portion between the main flow passage and the sub-flow passage, and phase cancellation occurs.

As can be seen from FIG. 6, in Example 1, a high transmission loss appears at a frequency of 2.27 kHz, which is 300 Hz lower than in Comparative Example 1. As can be seen from FIG. 4, at a frequency of 2.27 kHz, the phase of the sound pressure is inverted in the junction portion between the main flow passage and the sub-flow passage, and phase cancellation occurs.

As can be seen from FIG. 9, in Example 2, a high transmission loss appears at 2.03 kHz, which is 540 Hz lower than in Comparative Example 1. As can be seen from FIG. 10, at a frequency of 2.03 kHz, the phase of the sound pressure is inverted in the junction portion between the main flow passage and the sub-flow passage, and phase cancellation occurs.

As can be seen from FIG. 11, in Examples 1 and 2, the peak of the transmission loss is shifted to the low frequency side as compared to Comparative Example 1, and the transmission loss is larger than that in Comparative Example 1 even on the low frequency side away from the peak. Since a low-frequency sound has a large wavelength, it is difficult to deaden the sound in the interference-type silencer according to the related art. However, in the silencing structure according to the embodiment of the present invention, it can be seen that, since the sound speed reduction effect of the sound absorbing material contributes more significantly to lower frequencies, the low-frequency sound can be effectively deadened by the effect of the sound absorbing material.

As can be seen from the above results, in a case where the sounds having the same frequency are to be deadened, the size of the silencing structure according to the example can be smaller than that in Comparative Example 1.

### Example 3

A silencing structure was produced in the same manner as in Example 1 except that the thickness of the sound absorbing material was changed.

The total thickness of the sound absorbing material was set to 5 mm (2.5 mm on one side), 10 mm (5 mm on one side), 15 mm (7.5 mm on one side), 20 mm (10 mm on one side), 25 mm (12.5 mm on one side), and 30 mm (15 mm on one side).

### [Evaluation]

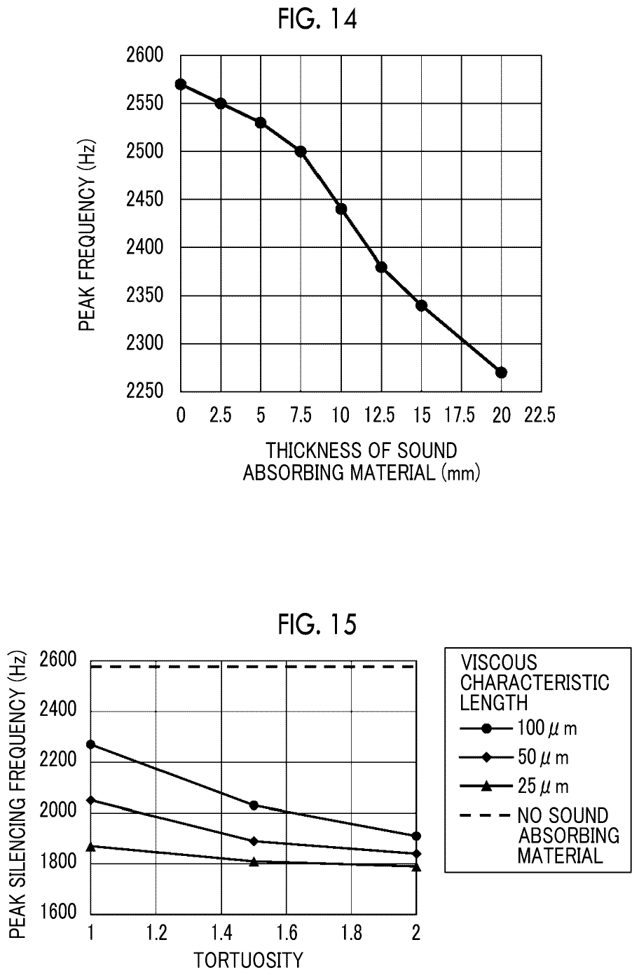

The transmission loss of the silencing structure in which the thickness of the sound absorbing material was changed was measured by the same method as described above. The results are shown in FIG. 13. In addition, FIG. 14 shows a relationship between the thickness of the sound absorbing material and the frequency at which the transmission loss reaches its peak.

As can be seen from FIGS. 13 and 14, in a case where the total thickness of the sound absorbing material is equal to or greater than 10 mm, the amount of shift of the frequency with respect to the thickness is large. In this configuration, in a case where the total thickness was 10 mm, the peak frequency shifted by 50 Hz as compared to a case where there was no sound absorbing material (Comparative Example 1). In addition, as can be seen from FIG. 14, the total thickness is equal to or greater than 20 mm, the gradient is further increased, and the amount of shift is 130 Hz, exceeding 100 Hz. Further, in a case where the total thickness is equal to or greater than 30 mm, and the amount of shift is 230 Hz, which is about 1/10 of the peak frequency in a case where there is no sound absorbing material (Comparative Example 1).

Therefore, it can be seen that the total thickness of the sound absorbing material disposed in the sub-flow passage is preferably equal to or greater than 10 mm, more preferably equal to or greater than 20 mm, and still more preferably equal to or greater than 30 mm.

### Example 4

A simulation was performed using the finite element method (COMSOL) in the same manner as in Example 1 except that the viscous characteristic length of the sound absorbing material was changed to 25 μm, 50 μm, and 100 μm and the tortuosity was changed to 1, 1.5, and 2.

### [Evaluation]

The transmission loss of the produced silencing structure was calculated by simulation, and the peak frequency was calculated. FIG. 15 shows a relationship between the viscous characteristic length and tortuosity and the peak frequency (peak silencing frequency) of the transmission loss.

As can be seen from FIG. 15, as the viscous characteristic length is smaller, the peak frequency is lower even in a case where the tortuosity is low. In addition, it can be seen that the frequency is lower as the tortuosity is higher.

The sound absorbing material was modeled using Expression (1) and Expression (2) described above. The flow resistance was set to 10000 Rayls, the porosity was set to 0.90, and the typical thermal viscous length=2× the viscous characteristic length was established for the sound absorbing material. The ratio of the speed of sound in the sound absorbing material to the speed of sound in air was calculated while the tortuosity and the viscous characteristic length were changed.

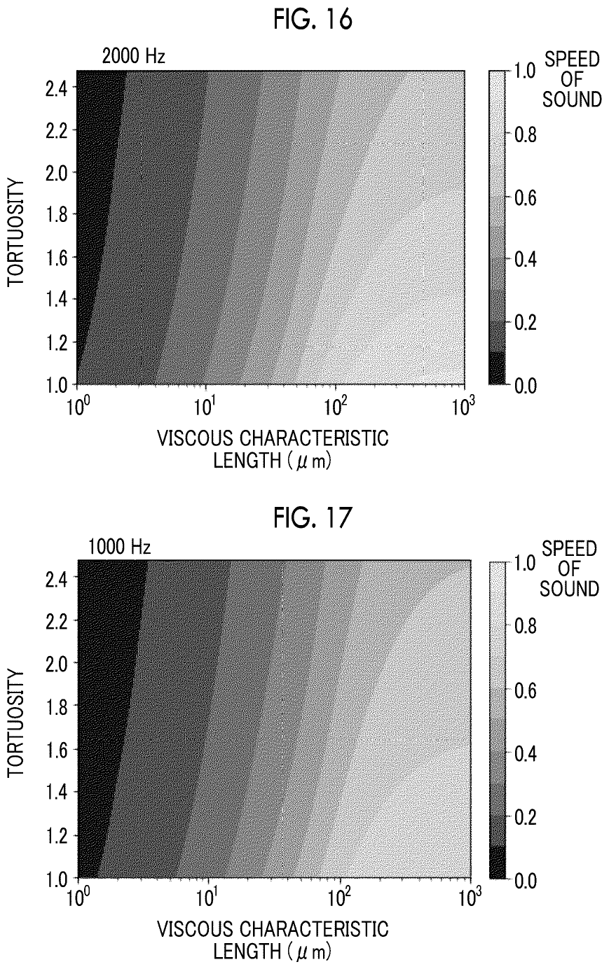

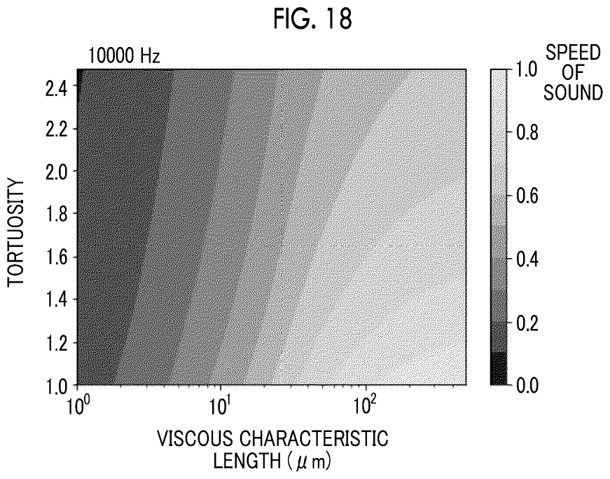

FIG. 16 shows the results in a case where the frequency of the sound is 2000 Hz. FIG. 17 shows the results in a case where the frequency of the sound is 1000 Hz. FIG. 18 shows the results in a case where the frequency of the sound is 10000 Hz. According to the A-characteristics, 2000 Hz is the frequency band with the highest audibility.

As can be seen from FIGS. 16 to 18, a small characteristic viscosity length contributes most to the sound speed ratio. In a case of a large viscous characteristic length, the tortuosity also strongly affects the sound speed ratio.

In addition, in a case where the viscous characteristic length is equal to or less than 300 μm, the sound speed ratio is less than 0.9 even at a tortuosity of 1.0. Furthermore, in a case where the viscous characteristic length is less than 100 μm, the sound speed ratio is equal to or less than 0.8 at a frequency of 2000 Hz. In addition, the sound speed ratio is equal to or less than 0.9 even at a high frequency of 10000 Hz. Further, in a case where the viscous characteristic length is equal to or less than 70 μm, the sound speed ratio is equal to or less than 0.7. In a case where the viscous characteristic length is equal to or less than 50 μm, the sound speed ratio is equal to or less than 0.6. As described above, even in a case where the tortuosity is 1.0, the speed of sound can be slowed down by reducing the viscous characteristic length.

Therefore, it can be seen that the viscous characteristic length is preferably equal to or less than 300 μm, more preferably equal to or less than 100 μm, still more preferably equal to or less than 70 μm, and particularly preferably equal to or less than 50 μm.

In addition, in a case where the tortuosity can be increased, the speed of sound can be slowed down even at a large viscous characteristic length. In particular, in a case where the tortuosity is equal to or greater than 1.1, the sound speed ratio can be sufficiently set to 0.9 or less even in a case of a large viscous characteristic length (approximately 1000 μm), which is effective in imparting the phase difference between the main flow passage and the sub-flow passage.

### Example 5

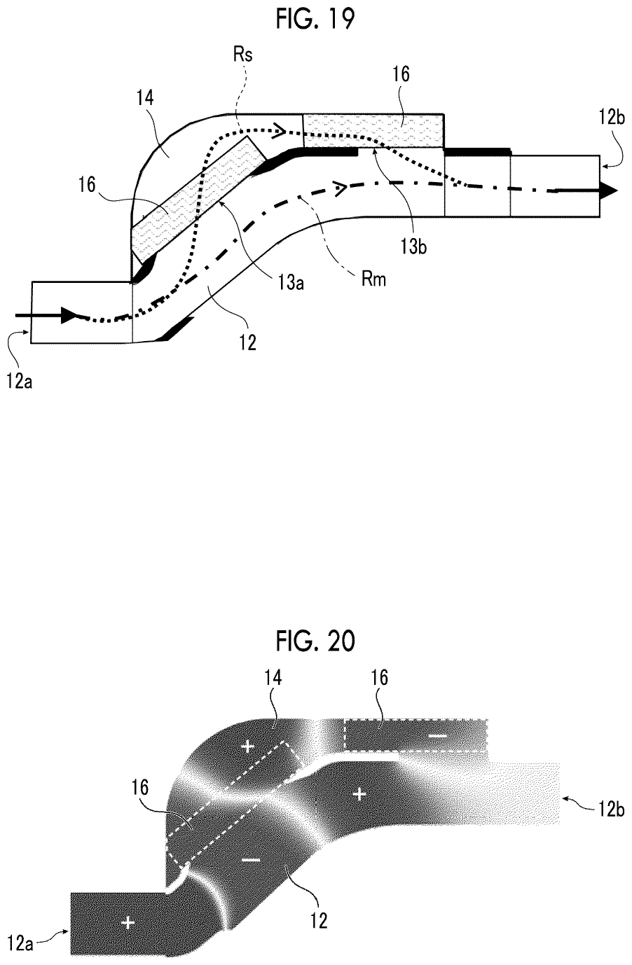

A silencing structure made of ABS resin shown in FIG. 19 was produced by injection molding. The thickness of the ABS resin of an outer wall was set to 3 mm, and a wall member separating the main flow passage 12 and the sub-flow passage 14 was formed in the silencing structure (black thick line in FIG. 19). The flow passages closer to the inlet 12a and the outlet 12b had a square shape and had a width of 28 mm, and the main flow passage 12 and the sub-flow passage 14 were fluidically separated from each other using the wall member and the sound absorbing material 16 (Calmflex F2 manufactured by Inoac Corporation). In addition, the width of the flow passage was gradually increased near a connection portion between the wall member and the sound absorbing material 16 to reduce the speed of wind near the sound absorbing material 16. As a result, wind noise was less likely to occur.

The transmission loss of the silencing structure was measured in the same manner as described above. The results showed that 2500 Hz was the peak of the amount of silencing and a silencing effect of 33 dB was obtained.

For the silencing structure shown in FIG. 19, a simulation was performed using COMSOL in the same manner as described above, and the sound pressure distribution inside the silencing structure at 2500 Hz was calculated. The results are shown in FIG. 20.

As can be seen from FIG. 20, the phase of the sound pressure is inverted in the connection position 13b (junction portion) between the main flow passage 12 and the sub-flow passage 14, and the sound is deadened by interference. In addition, as can be seen from FIG. 20, in the sound absorbing material 16 at the connection position 13a (branch portion), an aspect in which the angle of the wave surface of the sound (determined by a white portion with a sound pressure of 0) changes and the phase is delayed can be clearly simulated.

The effects of the present invention are obvious from the above results.

### EXPLANATION OF REFERENCES

10, 10b: silencing structure
12: main flow passage
12a: inlet
12b: outlet
13a: connection position (branch portion)
13b: connection position (junction portion)
14: sub-flow passage
15: wall member
16: sound absorbing material
18: expansion portion
20: back space
21: opening portion
22: sound absorbing material

What is claimed is:

1. A silencing structure comprising:
a main flow passage that is connected to an inlet and an outlet;
a sub-flow passage that branches off from the main flow passage and returns to the main flow passage; and
a sound absorbing material that is disposed at least at a connection position between the main flow passage and the sub-flow passage,
wherein the sub-flow passage is not directly connected to the inlet and the outlet,
a length of a path that is from the inlet to the outlet and includes the sub-flow passage is equal to or greater than a length of a path that is from the inlet to the outlet and includes only the main flow passage, and
for a sound with a frequency to be cancelled, a phase difference between a sound that passes through the path including only the main flow passage and a sound that passes through the path including the sub-flow passage is greater than 90 degrees and less than 270 degrees such that interference occurs to deaden the sound.

2. The silencing structure according to claim 1,
wherein a total thickness of the sound absorbing material is equal to or greater than 10 mm in a direction of the path including the sub-flow passage.

3. The silencing structure according to claim 1,
wherein the main flow passage and the sub-flow passage are separated by a non-air-permeable wall member except for the connection position.

4. The silencing structure according to claim 1,
wherein a viscous characteristic length of the sound absorbing material is equal to or less than 300 μm.

5. The silencing structure according to claim 1,
wherein a tortuosity of the sound absorbing material is equal to or greater than 1.1.

6. The silencing structure according to claim 1, further comprising:
an expansion portion that is expanded more than an area of the inlet and the outlet; and
a wall member that is disposed in the expansion portion and defines the main flow passage communicating from the inlet to the outlet,
wherein a region of the expansion portion, which is separated from the main flow passage by the wall member, is the sub-flow passage.

7. The silencing structure according to claim 1,
wherein the sound absorbing material has a foam structure.

8. The silencing structure according to claim 1,
wherein the main flow passage is a ventilation passage.

9. The silencing structure according to claim 1,
wherein a fan is connected to the inlet such that the main flow passage acts as a ventilation passage, and
a sound of the fan is the sound to be deadened.

10. The silencing structure according to claim 2,
wherein the main flow passage and the sub-flow passage are separated by a non-air-permeable wall member except for the connection position.

11. The silencing structure according to claim 2,
wherein a viscous characteristic length of the sound absorbing material is equal to or less than 300 μm.

12. The silencing structure according to claim 2,
wherein a tortuosity of the sound absorbing material is equal to or greater than 1.1.

13. The silencing structure according to claim 2, further comprising:
an expansion portion that is expanded more than an area of the inlet and the outlet; and
a wall member that is disposed in the expansion portion and defines the main flow passage communicating from the inlet to the outlet,
wherein a region of the expansion portion, which is separated from the main flow passage by the wall member, is the sub-flow passage.

14. The silencing structure according to claim 2,
wherein the sound absorbing material has a foam structure.

15. The silencing structure according to claim 2,
wherein the main flow passage is a ventilation passage.

16. The silencing structure according to claim 2,
wherein a fan is connected to the inlet such that the main flow passage acts as a ventilation passage, and
a sound of the fan is the sound to be deadened.

17. The silencing structure according to claim 3,
wherein a viscous characteristic length of the sound absorbing material is equal to or less than 300 μm.

18. The silencing structure according to claim 3,
wherein a tortuosity of the sound absorbing material is equal to or greater than 1.1.

19. The silencing structure according to claim 3, further comprising:
an expansion portion that is expanded more than an area of the inlet and the outlet; and
a wall member that is disposed in the expansion portion and defines the main flow passage communicating from the inlet to the outlet,
wherein a region of the expansion portion, which is separated from the main flow passage by the wall member, is the sub-flow passage.

20. The silencing structure according to claim 3,
wherein the sound absorbing material has a foam structure.
